(19) United States
(12) Patent Application Publication
(10) Pub. No.: US 2014/0279004 A1
(43) Pub. Date: Sep. 18, 2014

(54) SEPARATING OFFERS ASSOCIATED WITH ONE ACCOUNT BASED ON GEOLOCATION OF ACCOUNT USERS

(71) Applicant: BANK OF AMERICA CORPORATION, Charlotte, NC (US)

(72) Inventors: Susan Smith Thomas, Gastonia, NC (US); Matthew A. Calman, Charlotte, NC (US); David M. Grigg, Rock Hill, SC (US)

(73) Assignee: Bank of America Corporation, Charlotte, NC (US)

(21) Appl. No.: 13/826,403

(22) Filed: Mar. 14, 2013

(51) Int. Cl. G06Q 30/02

(52) U.S. Cl. CPC G06Q 30/0261
USPC 705/14.58

(57) ABSTRACT

Embodiments of the invention are directed to systems, methods and computer program products for micro-targeting an offer based on geolocation information. An exemplary apparatus is configured to: determine a first user is accessing an account, wherein the account is associated with a first user and a second user, wherein the account is presented on a user interface; and in response to determining the first user is accessing the account, transmit a first offer to the first user based on geolocation information associated with the first user, wherein the first offer is presented on the user interface, and wherein the first offer enables the first user to receive a discount or a rebate on a transaction associated with the first offer. The apparatus may also be configured to transmit, in real-time, offers to the first user based on at least one of real-time or historical geolocation information associated with the first user.

### BACKGROUND

There may be multiple users associated with an account. There is a need to provide offers customized for each user associated with the account.

### BRIEF SUMMARY

In some embodiments, an apparatus is provided for micro-targeting users associated with an account based on geolocation information associated with each user. The apparatus comprises a memory; a processor; and a module stored in the memory, executable by the processor, and configured to: determine a first user is accessing an account, wherein the account is associated with the first user and a second user, wherein the account is presented on a user interface; and in response to determining the first user is accessing the account, transmit a first offer to the first user based on geolocation information associated with the first user, wherein the first offer is presented on the user interface, and wherein the first offer enables the first user to receive a discount or a rebate on a transaction associated with the first offer.

In some embodiments, the module is further configured to: in response to determining the second user is accessing the account, transmit a second offer to the second user, wherein the second offer is transmitted to the second user based on geolocation information associated with the second user, wherein the second offer is presented on the user interface, and wherein the second offer enables the second user to receive a discount or a rebate on a transaction associated with the second offer.

In some embodiments, the geolocation information comprises a geographical location.

In some embodiments, the geolocation information comprises a network location.

In some embodiments, the geolocation information is associated with transaction information.

In some embodiments, the geolocation information is not associated with transaction information.

In some embodiments, the geolocation information comprises substantially real-time geolocation information, wherein the substantially real-time geolocation information is captured based on receiving permission from the first user.

In some embodiments, the geolocation information comprises historical first geolocation information, wherein the historical geolocation information is captured based on receiving permission from the first user.

In some embodiments, the geolocation information comprises substantially real-time geolocation information, wherein transmitting the first offer to the first user based on geolocation information associated with the first user comprises: comparing the substantially real-time geolocation information with historical geolocation information associated with the first user; and in response to determining a substantial match between the substantially real-time geolocation information and the historical geolocation information, transmitting the first offer to the first user.

In some embodiments, the first offer is not based on geolocation information associated with the second user.

In some embodiments, the module is configured to determine the first user is accessing the account based on at least one of authentication information provided by the first user, identification information provided by the first user, identification information associated with a device used by the first user to access the account, location information associated with the device used by the first user to access the account, or account access history of the first user.

In some embodiments, the first offer is different from a second offer associated with the second user.

In some embodiments, the first offer is similar to a second offer associated with the second user.

In some embodiments, the account comprises a financial institution account.

In some embodiments, when the first offer is presented on the user interface, the first offer is presented alongside a transaction in a transaction history associated with the financial institution account, wherein the first offer is related to the transaction in the transaction history.

In some embodiments, the first user and the second user are part of a family. In other embodiments, the first user and the second user may not be part of the same family (e.g., the first user may be unrelated to the second user).

In some embodiments, the first offer is transmitted to the first user based on matching offer information associated with the first offer to account information and user information associated with the first user, wherein the account information associated with the first user comprises a first transaction history associated with the account, wherein the first transaction history is attributable to the first user, and wherein the first transaction history comprises at least one of a type of a transaction, a frequency associated with the transaction, an amount associated with the transaction, or a merchant associated with the transaction, and wherein the user information associated with the first user comprises personal information associated with at least one of the first user, a family member of the first user, or a friend of the first user, wherein the personal information comprises at least one of demographic information, salary information, contact information, residence address information, job profile information, education information, or social network information, wherein the first offer is presented on the user interface of a portable mobile communication device, and wherein after the first user executes the transaction associated with the first offer, processing of the transaction is executed as part of a batch processing operation, wherein the batch processing operation comprises processing a plurality of accounts.

In some embodiments, the account comprises at least one of a social network account, an email account, or a text message account.

In some embodiments, a method is provided for micro-targeting users associated with an account based on geolocation information associated with each user. The method comprises: determining a first user is accessing an account, wherein the account is associated with a first user and a second user, wherein the account is presented on a user interface; and in response to determining the first user is accessing the account, transmitting a first offer to the first user based on geolocation information associated with the first user, wherein the first offer is presented on the user interface, and wherein the first offer enables the first user to receive a discount or a rebate on a transaction associated with the first user.

In some embodiments, a computer program product is provided for micro-targeting users associated with an account based on geolocation information associated with each user. The computer program product comprises a non-transitory computer-readable medium comprising a set of codes for causing a computer to: determine a first user is accessing an account, wherein the account is associated with a first user and a second user, wherein the account is presented on a user interface; and in response to determining the first user is accessing the account, transmit a first offer to the first user based on geolocation information associated with the first user, wherein the first offer is presented on the user interface, and wherein the first offer enables the first user to receive a discount or a rebate on a transaction associated with the second user.

### BRIEF DESCRIPTION OF THE DRAWINGS

Having thus described embodiments of the invention in general terms, reference will now be made to the accompanying drawings, where:

FIG. 1 is a flowchart illustrating a general process flow for presenting offers based on geolocation of account users, in accordance with embodiments of the present invention; and

FIG. 2 is a block diagram illustrating technical components of a system for implementing the various processes described herein, in accordance with embodiments of the present invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

Embodiments of the invention are directed to systems, methods and computer program products for micro-targeting offers to multiple users associated with an account based on geolocation information associated with each user. The invention enables an entity to send targeted offers to a user within a household that enables the user to receive at least one of a discount or a rebate on a purchase from a third-party merchant. As used herein, an offer may also be referred to as a coupon (e.g., an electronic coupon).

In some embodiments, an “entity” may be a financial institution. For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In some embodiments, the entity may allow a user to establish an account with the entity. An “account” may be the relationship that the user has with the entity. Examples of accounts include a deposit account, such as a transactional account (e.g., a banking account), a savings account, an investment account, a money market account, a time deposit, a demand deposit, a pre-paid account, a credit account, a non-monetary user profile that includes only personal information associated with the user, or the like. The account is associated with and/or maintained by the entity. In other embodiments, an entity may not be a financial institution. In still other embodiments, the entity may be the merchant associated with an offer. In some embodiments, the “user” may be a customer (e.g., an account holder or a person who has an account (e.g., banking account, credit account, or the like) at the entity).

An entity (e.g., a financial institution) may send an offer to a user (e.g., an account holder). The offer may be presented the user via at least one of the user's electronic banking account (e.g., online banking account, mobile banking account on a portable mobile communication device, or the like), the user's social network account, email, or text message. In some embodiments, the user may select an option associated with the presented offer to accept the offer. When the user accepts the offer, the offer is activated so that if the user uses an eligible payment method (as determined by the entity or the merchant) to make a purchase associated with the offer, the user receives the benefit associated with the offer. In other embodiments, the offer may be automatically activated if the user has previously chosen to automatically activate offers associated with particular types (e.g., associated with particular merchants or product or service types). In some embodiments, the entity or the merchant may determine that a user may choose among multiple eligible payment methods in order to make a purchase associated with the offer.

As an example, the activated offer may be a rebate of $5 on a purchase of $20 from a department store. The user may decide to use the offer by visiting the department store and making a purchase of $20. In some embodiments, at the point of sale, the user pays $20 for the user's purchase using an eligible payment method determined by the financial institution or the merchant (e.g., payment card, mobile device payment, check, or the like). When the transaction is processed by the financial institution at a predetermined settlement time in the future (e.g., as part of a periodic batch processing operation to generate monthly account statements), the financial institution provides a rebate of $5 to the user's financial institution account. Therefore, the department store, at the point of sale, may have no knowledge that the user will receive a rebate at some point in the future. In some embodiments, even the user may not be aware of the rebate at the point of sale (e.g., if the offer was automatically activated). In other embodiments, the point of sale terminal may provide an indication to at least one of the department store or the user that the user will receive a rebate at some point in the future.

Referring now to FIG. 1, a general process flow 100 is provided for micro-targeting an offer based on geolocation information. At block 110, the method comprises determining a first user is accessing an account, wherein the account is associated with the first user and a second user (e.g., a joint account), wherein the account is presented on a user interface. At block 120, the method comprises in response to determining the first user is accessing the account, transmitting a first offer to the first user based on geolocation information associated with the first user, wherein the first offer is presented on the user interface, and wherein the first offer enables the first user to receive a discount or a rebate on a transaction associated with the first offer. As used herein, geolocation information may also be referred to as location information, positioning information, position information, global positioning information, network location, or the like. Geolocation information associated with the user refers to geographical or network information associated with a location of the user's mobile device (e.g., mobile phone, tablet, watch, laptop, other portable computing device, or the like).

The present invention has several applications. For example, when a first user associated with an account accesses the account, the first user is presented with offers based on the first user's geolocation information (e.g., real-time geolocation information, historical geolocation information, or the like). Similarly, when a second user associated with the account accesses the account, the second user is presented with offers based on the second user's geolocation information (e.g., real-time geolocation information, historical geolocation information, or the like). As another example, an apparatus (e.g., a server) receives real-time geolocation information associated with the first user when the first user visits the premises of a merchant or is located within a predetermined distance to the premises of the merchant. In such an example, the apparatus compares the first user's real-time geolocation information with historical geolocation information associated with the first user to determine whether to transmit an offer, in real-time, to the first user's mobile device. If there is a match between the real-time geolocation information and the historical geolocation information, the apparatus transmits an offer, in real-time, to the first user's mobile device. For example, if the apparatus determines that the first user is location in a merchant's premises and that the first user has previously visited the merchant's premises, the apparatus may transmit an offer, in real-time, to the first user's mobile device.

As used herein, geolocation information includes global positioning information. Global positioning information may include any information collected from methods, systems, apparatus, computer programs, or the like, involving locating a user's position relative to satellites, fixed locations, beacons, transmitters, the apparatus, system, or server described herein, or the like. In some instances, global positioning information may be collected from a global positioning system (GPS) device, such as a navigation system. Such a navigation system may be, but is not limited to, hardware and/or software that is part of a mobile phone, smartphone, personal digital assistant (PDA), automobile, watch, tablet, portable computing device, or a commercially available personal navigation system. The amount, nature and type of the global positioning information that is collected may depend on the entity's relationship with the user and the amount of information that the user has authorized the entity to collect or capture. In some embodiments, the global positioning information will be snapshots of the user's location at different times. For example, a snapshot of the user's location may be collected each time the GPS software, navigation system or application is activated. As another example, a snapshot of the user's location may be collected each time a user is located within the premises of a merchant or within a predetermined distance of a merchant. As another example, a snapshot of the user's location may be collected each time a user executes a transaction at a merchant (e.g., via the user's mobile device). The geolocation information may also include the destination entered by the user, recent searches for locations, attractions, addresses, or the like. In other instances, the geolocation information may be a route (e.g., a route to a particular merchant) being provided to the user, including destination, route, alternate routes, anticipated time of arrival, or the like. In other embodiments, geolocation information may comprise a network location associated with a user (e.g., an Internet Protocol (IP) address, a device address, a location of a telecommunication tower located close to or closest to or within a predetermined distance from the user's mobile device). In some embodiments, a user may need to register the user's mobile device with the entity in order to enable the entity to capture geolocation information associated with the mobile device. Therefore, a user may need to opt-in to a program that enables capture of geolocation information.

Geolocation information may or may not be associated with transaction information. For example, a user's geolocation information may be captured when the user executes a transaction at a merchant associated with a particular location. The geolocation information may either be transmitted directly via the mobile device or may be transmitted via the merchant's system (e.g., a merchant's payment terminal). As another example, a user's geolocation information may be captured based on the user visiting the merchant's premises (or being located within a predetermined distance of the merchant's premises) without actually executing a transaction at the merchant's premises. Therefore, when a user is located within the premises of a merchant or is located a predetermined distance from the merchant's premises, the user's mobile device transmits geolocation information associated with the user's mobile device to an apparatus (e.g., a server or other computing device). In other embodiments, the apparatus periodically pings the user's mobile device and receives geolocation information associated with the user's mobile device. In still other embodiments, the user's mobile device transmits geolocation information associated with the user's mobile device when the user executes a purchase transaction at a merchant. In still other embodiments, geolocation information associated with the merchant or the user's mobile device is stored with other transaction details associated with a transaction. The geolocation information may be stored in a database.

Offers may be generated based on the stored geolocation information. For example, a husband and wife may be associated with a single account. The offers presented to the husband on a user interface associated with the account (or the offers transmitted to the husband's mobile device) may be different from the offers presented to the wife on the user interface associated with the same account (or the offers transmitted to the wife's mobile device). For example, the offers presented to the husband may be based on geolocation information associated with the husband, and not based on geolocation information associated with the wife. Similarly, the offers presented to the wife may be based on geolocation information associated with the wife, and not based on geolocation information associated with the husband. As used herein, geolocation information may refer to at least one of real-time or historical geolocation information. As used herein, real-time geolocation information may refer to substantially real-time geolocation information.

In some embodiments, an offer may be transmitted to a first user's mobile device based on substantially real-time geolocation information associated with the first user's mobile device (also referred to as the first user's location or mobile device location). For example, a first user's location is determined to be within the premises associated with a merchant. The first user's location may be automatically transmitted to an apparatus described herein or the apparatus may periodically ping the mobile device for its location. When the apparatus receives the first user's location, the server compares the first user's substantially real-time location with historical geolocation information associated with the first user. The apparatus subsequently executes a “matching” process to determine whether to transmit an offer to the first user. If the apparatus determines that the first user has visited the first user's current location more than a predetermined number of times during a predetermined period (or has executed a predetermined number of purchase transactions during a predetermined period at the current location, i.e., at the merchant), the apparatus transmits, in real-time, an offer associated with the merchant to the first user. Therefore, the first user receives the offer (e.g., as a text message, multimedia message, pop-up message, or the like) on the first user's mobile device. The first user may then activate the offer (or the offer may be automatically activated) either prior to executing the transaction or after executing the transaction but prior to settlement of the transaction. Therefore, the first user will receive the rebate or discount associated with the offer.

In some embodiments, a husband and wife, who are associated with the same account, visit the premises of a merchant (or are both determined to be within a predetermined distance of a merchant). In such embodiments, the apparatus may separately receive geolocation information associated with both the husband and wife. The apparatus then compares the geolocation information with historical geolocation information associated with both the husband and wife. If the apparatus determines based on the historical geolocation information associated with the husband that the husband has visited the merchant's premises greater than or equal to a predetermined number of times in the past (or has executed at least a predetermined number of transactions at the merchant in the past), the apparatus transmits, in real-time, an appropriate offer to the husband's mobile device. If these conditions do not hold true for the husband, the apparatus does not transmit an offer to the husband's mobile device. Similarly, the apparatus may perform a similar analysis for the wife and either transmit or not transmit an offer to the wife's mobile device.

However, in some embodiments, since both the husband and wife are at the merchant's premises (or are both within a predetermined distance of the merchant's premises), the husband's and wife's geolocation information may be considered cumulatively. Therefore, if the husband and wife qualify for an offer based on their cumulative geolocation information, an offer is transmitted to either both the husband's and wife's mobile devices or is transmitted to whichever mobile device (between the husband's and wife's mobile devices) is determined to be located closest to a check-out counter or register (or some other computing terminal) at the merchant's premises. In some embodiments, even when the husband's and wife's geolocation information are considered separately, an appropriate offer is transmitted to both the husband's and wife's mobile devices if both the husband and wife are located at the merchant's premises (or within a predetermined distance to the merchant's premises).

In some embodiments, the first user and the second user are part of the same family or household. Therefore, when the first user accesses an account using a computing device (e.g., a portable mobile communication device), the offers presented to the first user are different from those presented to the second user when the second user accesses the account either using the same computing device or a different computing device. Thus, when a first offer associated with the first user is presented to the first user on the user interface, a second offer associated with the second user is not presented to the first user on the user interface. Therefore, the present invention enables segmenting the household such that different offers are presented to different members of the household, wherein the household members may or may not share an account (e.g., a financial institution account).

The system described herein is configured to determine which user (first user or second user) is accessing an account based on at least one of authentication information provided by the user, identification information provided by the user, location information associated with the user's device, or identification information associated with a device used by the user to access the account. For example, the system may identify a user based on authentication credentials used by the user to log into the account. As a further example, after logging into the account, the system initiates presentation of a prompt asking the user to identify himself or herself. For example, the system initiates presentation of a drop-down list comprising a plurality of users associated with the account. Once the user selects a user from the list, the system may prompt the user to enter pre-configured authentication credentials associated with the user. As a further example, the system may determine that the user accessing the account is the first user based on a location of a device accessing the account. The location may be determined using global positioning system (GPS) information or network address information (e.g., IP address) associated with the device being used to access the account. In other embodiments, the system may be configured to determine which user is accessing an account based on previous access history of the user. For example, if the first user accesses the account during the mornings and the second user accesses the account during the evenings, there is a high likelihood that the user is the first user when the account is accessed during a morning.

In some embodiments, the first offer associated with the first user is different from a second offer associated with the second user. For example, an offer presented to the wife (e.g., offer for female clothes store in a first location) in the family may be different from an offer (e.g., offer for male clothes store in a second location) presented to the husband. In other embodiments, the first offer associated with the first user may be similar to a second offer associated with the second user. For example, an offer presented to the wife (e.g., a family restaurant offer) may also be presented to the husband.

In some embodiments, the account (or the electronic environment) in which the offer is presented is a financial institution account. In other embodiments, the account may be a social network account, an email account, or a text message account. When the offer is presented on the user interface of a financial institution account, the offer is presented alongside a transaction in a transaction history associated with the financial institution account, wherein the offer is related to the transaction in the transaction history. When the first user views a transaction history associated with the account, the first user may view transactions attributable solely to the first user, may or may not be able to view transactions attributable to both the first user and the second user, and may or may not be able to view transactions attributable solely to the second user.

In some embodiments, the account information and/or user information associated with a user may also be considering whether to transmit an offer to the user and the type of offer to transmit to the user. The geolocation information, account information and/or user information associated with the various users in the household may be considered cumulatively for various purposes described herein. Alternatively, the geolocation information, account information and/or user information associated with or attributable to each user in the household may be considered separately for other purposes described herein.

As described herein, prior to transmitting an offer to a user (e.g., the first user), the system determines geolocation information, user information, and account information associated with the first user. The account information comprises a transaction history associated with an account (e.g., a financial institution account) associated with both the first user and a second user, wherein the transactions in the transaction history are attributable to the first user (and not attributable to the second user). The transaction history comprises at least one of a type of a transaction, a frequency associated with the transaction, an amount associated with the transaction, or a merchant associated with the transaction.

In some embodiments, transactions in the transaction history are attributable to the first user if the transactions were made using a payment method associated with the first user (e.g., the first user's payment card, first user's mobile device, physical check associated with the first user, or the like). In some embodiments, the first user's payment card number (or other identification information) may be different from the second user's payment card number (or other identification information), and the payment card number (or other identification information) associated with the transaction can be used identify whether the first user or second user executed the transaction. Any transactions attributable solely to the second user are excluded when determining account information associated with the first user. In some embodiments, transactions executed using the first user's mobile device are attributable solely to the first user. In other embodiments, transactions executed using the first user's mobile device are attributable to both the first user and a second user associated with an account if the first user and second user are determined to be located at the same merchant's premises based on geolocation information associated with the first user's and the second user's mobile devices.

In some embodiments, when the first user or the second user logs into (or authenticates into) an account, he or she can tag a transaction to indicate whether the transaction is attributable to just the first user, just the second user, or to both the first and second users. In other embodiments, each user can tag only those transactions that he or she executed, and cannot tag other transactions in the transaction history of an account. For example, the first user can tag a transaction that the first user executed to indicate that the transaction is attributable to just the first user, or is attributable to both the first user and the second user. In this example, the first user may be prevented from at least one of viewing or tagging transactions executed by the second user. However, if the second user previously tagged a transaction as being attributable to both the first user and the second user, the first user may be able to view the transaction and may be able to modify the tagging of the transaction (e.g., the first user may remove himself or herself from being associated with the transaction).

Transactions that are attributable to both the first user and the second user may or may not be considered when determining account information associated with the first user. For example, if the first user and the second user are part of a family, and a transaction associated with a first user is a $50 transaction at a family restaurant, the system may interpret the transaction as being attributable to both the first user and the second user even though the transaction was executed by the first user, and consequently, the system will transmit an offer related to this transaction to both the first user and the second user. In this example, the system may interpret that the first user was dining with the second user at the family restaurant. However, in other embodiments, the system will transmit an offer related to this transaction only to the first user, and not to the second user, because the transaction was executed by the first user, and not the second user.

As another example, if the first user executes a transaction associated with a fast food restaurant, and the second user executes a separate transaction associated with the same fast food restaurant, an offer related to these transactions may be transmitted to both the first user and the second user. As explained herein, the offer (e.g., a rebate or discount amount associated with the offer) may be based on an aggregate of the transactions executed by both the first user and the second user. In this example, the first user or the second user may have executed the transaction using an account associated with both the first user and the second user. Alternatively, the first user or the second user may have executed the transaction using a separate account not associated with the other user.

In other embodiments, account information associated with the first user may include account information associated with other accounts (e.g., financial institution accounts) associated with the first user. These other accounts may not be associated with or accessible to the second user. In some embodiments, some transactions in the transaction history of an account are excluded from the account information associated with the first user. These transactions may be associated with a predetermined list of merchants, activities, or the like.

As described herein, the user information associated with a user (e.g., the first user) comprises personal information associated with at least one of the user, a family member of the user, or a friend of the user. As described herein, the personal information comprises at least one of demographic information, salary information, contact information, residence address information, job profile information, education information, or social network information.

Additionally, the offer is transmitted to the user (e.g., the first user) based on the user not being excluded by at least one user exclusion rule and the merchant not being excluded by at least one merchant exclusion rule. The user (e.g., the first user) receives the at least one of the discount or the rebate associated with an offer after the user executes a purchase transaction associated with the offer. For example, after the user executes a purchase transaction associated with the offer, the offer and the purchase transaction are processed as part of a batch processing operation, wherein the batch processing operation comprises processing a plurality of financial institution accounts.

In some embodiments, at settlement, an offer (e.g., an activated offer or an offer substituted for the activated offer) is applied to the largest transaction (e.g., purchase transaction) that qualifies for the offer during a predetermined period (e.g., the previous week). In other embodiments, the offer is applied to multiple transactions that qualify for the offer during a predetermined period. In such embodiments, the offer may be applied individually to each qualifying transaction, or at least some (or all) of the qualifying transactions during the predetermined period may be aggregated and the offer is applied to the aggregate. In other embodiments, the offer is applied to at least one transaction that occurs during a period defined by the merchant (e.g., from 4 PM to 6 PM on a particular day). In other embodiments, the offer is applied to at least one transaction greater than a predetermined amount that occurs during a predetermined period (e.g., a period defined by the merchant). In other embodiments, the offer is applied to the first (or second, or third, or the like) transaction greater than a predetermined amount (and/or less than a second predetermined amount) after the user (e.g., the first user) activated the offer. In other embodiments, the offer is applied to the largest transaction on the first day (or other predetermined period such as a particular second, minute, hour, day, week, month, or the like) when the user makes a transaction after activating the offer. Therefore, for example, the user activates an offer on Monday. On Wednesday morning, the user executes a $10 transaction that qualifies for the offer. On Wednesday evening, the user executes a $20 transaction that qualifies for the offer. In this example, the offer is applied to the $20 transaction, and not to the $10 transaction. In some embodiments, the date of a transaction is the date when a user executes the transaction. In other embodiments, the date of a transaction is the date when the merchant settles the transaction.

In some embodiments, even if the offer is presented to and activated by a first user associated with an account, a second user associated with the account may execute a purchase transaction for which the offer is applied during the batch processing operation described herein. In some embodiments, in order to receive the discount or rebate associated with the activated offer, the second user may execute the purchase transaction using the account associated with both the first user and the second user.

In some embodiments, the system described herein may determine that the user (e.g., the first user) has activated an offer (e.g., the first offer), but has not made a purchase associated with the offer for a predetermined period after activating the offer. Additionally, the system may determine, based on the user's account information (e.g., transaction history), that the user has made purchases for goods or services at a merchant that competes with the merchant associated with the activated offer. In order to encourage the user to make a purchase associated with the activated offer, the system may adjust the offer (e.g., increase the rebate or discount amount associated with the offer, replace the merchant associated with the offer with the merchant from which the user made purchases during the predetermined period, or the like). The offer adjustment may be communicated to the user to encourage the user to make a purchase associated with the adjusted offer. Additionally or alternatively, the system may, at the time of settlement of the user's purchase made during the predetermined period after activating the offer, substitute the offer with the another offer so that the user receives a discount or rebate on the user's purchase.

Referring now to FIG. 2, FIG. 2 presents an exemplary block diagram of the system environment 200 for implementing any of the process flows described herein, in accordance with embodiments of the present invention. As illustrated, the system environment 200 includes a network 210, a system 230, and a user input system 240. Also shown in FIG. 2 is a user 245 of the user input system 240. The user input system 240 may be a mobile device (e.g., a portable mobile communication device) described herein. The user 245 may be a person (e.g., an account holder) who uses the user input system 240 to execute a user application 247. The system 230 may be an apparatus, a server, or other computing device described herein. The user application 247 and/or the system application 237 may incorporate one or more parts of the process flow 100 or any other function described herein. The user 245 may use the user input system 240 to view an offer, activate an offer, view rebate received, or the like. The system 230 may receive geolocation information associated with the user, process the geolocation information to determine offers to transmit to the user, or the like.

As shown in FIG. 2, the system 230, and the user input system 240 are each operatively and selectively connected to the network 210, which may include one or more separate networks. In addition, the network 210 may include a local area network (LAN), a wide area network (WAN), and/or a global area network (GAN), such as the Internet. The network may also include a mobile telecommunication network. It will also be understood that the network 210 may be secure and/or unsecure and may also include wireless and/or wireline and/or optical interconnection technology.

The user input system 240 may include any computerized apparatus that can be configured to perform any one or more of the functions of the user input system 240 described and/or contemplated herein. For example, the user 245 may use the user input system 240 to transmit and/or receive information or commands to and from the system 230. In some embodiments, for example, the user input system 240 may include a personal computer system, a mobile computing device, a personal digital assistant, a mobile phone, a network device, and/or the like. As illustrated in FIG. 2, in accordance with some embodiments of the present invention, the user input system 240 includes a communication interface 242, a processor 244, a memory 246 having an user application 247 stored therein, and a user interface 249. In such embodiments, the communication interface 242 is operatively and selectively connected to the processor 244, which is operatively and selectively connected to the user interface 249 and the memory 246. In some embodiments, the user 245 may use the user application 247 to execute processes described with respect to the process flows described herein.

Each communication interface described herein, including the communication interface 242, generally includes hardware, and, in some instances, software, that enables the user input system 240, to transport, send, receive, and/or otherwise communicate information to and/or from the communication interface of one or more other systems on the network 210. For example, the communication interface 242 of the user input system 240 may include a wireless transceiver, modem, server, electrical connection, and/or other electronic device that operatively connects the user input system 240 to another system such as the system 230. The wireless transceiver may include a radio circuit to enable wireless transmission and reception of information.

Each processor described herein, including the processor 244, generally includes circuitry for implementing the audio, visual, and/or logic functions of the user input system 240. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as in the user application 247 of the memory 246 of the user input system 240.

Each memory device described herein, including the memory 246 for storing the user application 247 and other information, may include any computer-readable medium. For example, memory may include volatile memory, such as volatile random access memory (RAM) having a cache area for the temporary storage of information. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system.

As shown in FIG. 2, the memory 246 includes the user application 247. In some embodiments, the user application 247 includes an interface for communicating with, navigating, controlling, configuring, and/or using the user input system 240. In some embodiments, the user application 247 includes computer-executable program code portions for instructing the processor 244 to perform one or more of the functions of the user application 247 described and/or contemplated herein. In some embodiments, the user application 247 may include and/or use one or more network and/or system communication protocols.

Also shown in FIG. 2 is the user interface 249. In some embodiments, the user interface 249 includes one or more output devices, such as a display and/or speaker, for presenting information to the user 245. In some embodiments, the user interface 249 includes one or more input devices, such as one or more buttons, keys, dials, levers, directional pads, joysticks, accelerometers, controllers, microphones, touchpads, touchscreens, haptic interfaces, microphones, scanners, motion detectors, cameras, and/or the like for receiving information from the user 245. In some embodiments, the user interface 249 includes the input and display devices of a mobile device, which are operable to receive and display information.

FIG. 2 also illustrates a system 230, in accordance with an embodiment of the present invention. The system 230 may include any computerized apparatus that can be configured to perform any one or more of the functions of the system 230 described and/or contemplated herein. In accordance with some embodiments, for example, the system 230 may include a computer network, an engine, a platform, a server, a database system, a front end system, a back end system, a personal computer system, and/or the like. Therefore, the system 230 may be an external server as described herein. The system may be associated with (e.g., managed by) at least one of a financial institution, a merchant, any other entity that may not be associated with the financial institution or the merchant, an acquirer, an issuer, a card network entity, a user of an account, or the like. In some embodiments, such as the one illustrated in FIG. 2, the system 230 includes a communication interface 232, a processor 234, and a memory 236, which includes a system application 237 and a datastore 238 stored therein. As shown, the communication interface 232 is operatively and selectively connected to the processor 234, which is operatively and selectively connected to the memory 236.

It will be understood that the system application 237 may be configured to implement any one or more portions of the various user interfaces and/or process flow described herein. The system application 237 may interact with the user application 247. It will also be understood that, in some embodiments, the memory includes other applications. It will also be understood that, in some embodiments, the system application 237 is configured to communicate with the datastore 238, the user input system 240, or the like.

It will be further understood that, in some embodiments, the system application 237 includes computer-executable program code portions for instructing the processor 234 to perform any one or more of the functions of the system application 237 described and/or contemplated herein. In some embodiments, the system application 237 may include and/or use one or more network and/or system communication protocols.

In addition to the system application 237, the memory 236 also includes the datastore 238. As used herein, the datastore 238 may be one or more distinct and/or remote datastores. In some embodiments, the datastore 238 is not located within the system and is instead located remotely from the system. In some embodiments, the datastore 238 stores information or data described herein.

It will be understood that the datastore 238 may include any one or more storage devices, including, but not limited to, datastores, databases, and/or any of the other storage devices typically associated with a computer system. It will also be understood that the datastore 238 may store information in any known way, such as, for example, by using one or more computer codes and/or languages, alphanumeric character strings, data sets, figures, tables, charts, links, documents, and/or the like. Further, in some embodiments, the datastore 238 may include information associated with one or more applications, such as, for example, the system application 237. It will also be understood that, in some embodiments, the datastore 238 provides a substantially real-time representation of the information stored therein, so that, for example, when the processor 234 accesses the datastore 238, the information stored therein is current or substantially current.

It will be understood that the embodiment of the system environment illustrated in FIG. 2 is exemplary and that other embodiments may vary. As another example, in some embodiments, the system 230 includes more, less, or different components. As another example, in some embodiments, some or all of the portions of the system environment 200 may be combined into a single portion. Likewise, in some embodiments, some or all of the portions of the system 230 may be separated into two or more distinct portions.

In addition, the various portions of the system environment 200 may be maintained for and/or by the same or separate parties. It will also be understood that the system 230 may include and/or implement any embodiment of the present invention described and/or contemplated herein. For example, in some embodiments, the system 230 is configured to implement any one or more of the embodiments of any process flow described herein. Additionally, the system 230 is configured to initiate presentation of any of the user interfaces described herein.

In accordance with embodiments of the invention, the term “module” with respect to a system may refer to a hardware component of the system, a software component of the system, or a component of the system that includes both hardware and software. As used herein, a module may include one or more modules, where each module may reside in separate pieces of hardware or software.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory or the like) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. An apparatus for micro-targeting an offer based on geolocation information, the apparatus comprising:
a memory;
a processor; and
a module stored in the memory, executable by the processor, and configured to:
determine a first user is accessing an account, wherein the account is associated with the first user and a second user, wherein the account is presented on a user interface; and
in response to determining the first user is accessing the account, transmit a first offer to the first user based on geolocation information associated with the first user, wherein the first offer is presented on the user interface, and wherein the first offer enables the first user to receive a discount or a rebate on a transaction associated with the first offer.

2. The apparatus of claim 1, wherein the module is further configured to:
in response to determining the second user is accessing the account, transmit a second offer to the second user, wherein the second offer is transmitted to the second user based on geolocation information associated with the second user, wherein the second offer is presented on the user interface, and wherein the second offer enables the second user to receive a discount or a rebate on a transaction associated with the second offer.

3. The apparatus of claim 1, wherein the geolocation information comprises a geographical location.

4. The apparatus of claim 1, wherein the geolocation information comprises a network location.

5. The apparatus of claim 1, wherein the geolocation information is associated with transaction information.

6. The apparatus of claim 1, wherein the geolocation information is not associated with transaction information.

7. The apparatus of claim 1, wherein the geolocation information comprises substantially real-time geolocation information, wherein the substantially real-time geolocation information is captured based on receiving permission from the first user.

8. The apparatus of claim 1, wherein the geolocation information comprises historical first geolocation information, wherein the historical geolocation information is captured based on receiving permission from the first user.

9. The apparatus of claim 1, wherein the geolocation information comprises substantially real-time geolocation information, wherein transmitting the first offer to the first user based on geolocation information associated with the first user comprises:
comparing the substantially real-time geolocation information with historical geolocation information associated with the first user; and
in response to determining a substantial match between the substantially real-time geolocation information and the historical geolocation information, transmitting the first offer to the first user.

10. The apparatus of claim 1, wherein the first offer is not based on geolocation information associated with the second user.

11. The apparatus of claim 1, wherein the module is configured to determine the first user is accessing the account based on at least one of authentication information provided by the first user, identification information provided by the first user, identification information associated with a device used by the first user to access the account, location information associated with the device used by the first user to access the account, or account access history of the first user.

12. The apparatus of claim 1, wherein the first offer is different from a second offer associated with the second user.

13. The apparatus of claim 1, wherein the first offer is similar to a second offer associated with the second user.

14. The apparatus of claim 1, wherein the account comprises a financial institution account.

15. The apparatus of claim 14, wherein when the first offer is presented on the user interface, the first offer is presented alongside a transaction in a transaction history associated with the financial institution account, wherein the first offer is related to the transaction in the transaction history.

16. The apparatus of claim 1, wherein the first user and the second user are part of a family.

17. The apparatus of claim 1, wherein the first offer is transmitted to the first user based on matching offer information associated with the first offer to account information and user information associated with the first user, wherein the account information associated with the first user comprises a first transaction history associated with the account, wherein the first transaction history is attributable to the first user, and wherein the first transaction history comprises at least one of a type of a transaction, a frequency associated with the transaction, an amount associated with the transaction, or a merchant associated with the transaction, and wherein the user information associated with the first user comprises personal information associated with at least one of the first user, a family member of the first user, or a friend of the first user, wherein the personal information comprises at least one of demographic information, salary information, contact information, residence address information, job profile information, education information, or social network information, wherein the first offer is presented on the user interface of a portable mobile communication device, and wherein after the first user executes the transaction associated with the first offer, processing of the transaction is executed as part of a batch processing operation, wherein the batch processing operation comprises processing a plurality of accounts.

18. The apparatus of claim 1, wherein the account comprises at least one of a social network account, an email account, or a text message account.

19. A method for micro-targeting an offer based on geolocation information, the method comprising:
determining a first user is accessing an account, wherein the account is associated with a first user and a second user, wherein the account is presented on a user interface; and
in response to determining the first user is accessing the account, transmitting a first offer to the first user based on geolocation information associated with the first user, wherein the first offer is presented on the user interface, and wherein the first offer enables the first user to receive a discount or a rebate on a transaction associated with the first user.

20. A computer program product for micro-targeting an offer based on geolocation information, the computer program product comprising:
a non-transitory computer-readable medium comprising a set of codes for causing a computer to:
determine a first user is accessing an account, wherein the account is associated with a first user and a second user, wherein the account is presented on a user interface; and
in response to determining the first user is accessing the account, transmit a first offer to the first user based on geolocation information associated with the first user, wherein the first offer is presented on the user interface, and wherein the first offer enables the first user to receive a discount or a rebate on a transaction associated with the second user.
